(19) United States
(12) Patent Application Publication
(10) Pub. No.: US 2013/0149661 A1
(43) Pub. Date: Jun. 13, 2013

(54) DENTAL MODEL ARTICULATOR INCLUDING LATCH

(71) Applicant: DONG JUN YOO, SEOUL (KR)

(72) Inventor: DONG JUN YOO, SEOUL (KR)

(21) Appl. No.: 13/706,424

(22) Filed: Dec. 6, 2012

(30) Foreign Application Priority Data
Dec. 7, 2011 (KR) 20-2011-0010839

(51) Int. Cl. A61C 11/02

(52) U.S. Cl. CPC A61C 11/025
USPC 433/57

(57) ABSTRACT

Disclosed is a dental model articulator used to manufacture artificial teeth or prosthetic teeth at a dental technician's office. Particularly, the dental model articulator includes a latch adapted to fixedly latch a maxillary base to a mandibular base. The dental model articulator enables the manufacture of more sophisticated artificial teeth and prosthetic teeth as replacements for damaged teeth.

### FIELD OF TECHNOLOGY

The present invention relates to an orthodontic articulator that is used at a dental technician's office to implant artificial teeth or prosthetic teeth at a dental clinic. More particularly, the present invention relates to a dental model articulator constructed to include a latch adapted to simply fix a maxillary base, which is produced by injection molding to correspond to the upper jaw, to a mandibular base, which is produced by injection molding to correspond to the lower jaw, such that the maxillary base and the mandibular base move only upward and downward without moving left and right, thus being suitable for use in the manufacture of artificial teeth. In addition, the dental model articulator of the present invention is simply separated from and coupled to a dental model in the implantation of artificial teeth to replace decayed teeth or loose teeth caused by periodontitis or the fabrication of a prosthetic appliance for damaged teeth.

### BACKGROUND

A dental model articulator is generally used when a dental technician fixes a dental model cast from patient's teeth at a dental clinic to manufacture dental prosthetics, such as dentures. The articulator is a device that fixes the dental model in a three-dimensional positional relationship, like the human mouth, to mimic the maxillary and mandibular movements of teeth. That is, the articulator is greatly helpful as an auxiliary device that offers convenience in processing artificial teeth and prosthetic teeth. The dental model articulator includes a maxillary base and a mandibular base separated from each other. However, the dental model articulator tends to get loose and move left and right during manufacture of artificial teeth, etc. This tendency causes great inconvenience for a dental technician who actually participates in the manufactures of artificial teeth at a dental clinic. Such left and right movements are caused when the maxillary base and the mandibular base are not completely fixed to a hinge portion therebetween. When it is intended to replace with artificial teeth or combine with a prosthetic appliance, a dentist casts a model of patient's teeth at a dental clinic and sends the model to a dental technician' office where a dental technician makes artificial teeth or prosthetic teeth adapted for the model. Thereafter, the dentist attaches the artificial teeth or prosthetic teeth to the patient at the dental clinic.

Before actual attachment of the artificial teeth or prosthetic teeth to the patient, the dentist conducts a simulation to test whether an abnormality occurs when the patient uses the artificial teeth or prosthetic teeth. At this time, a dental device, called orthodontic articulator, is used for the test. The orthodontic articulator is constructed to have the same shape as the patient's teeth. When the dentist scrutinizes the contact areas or engaged portions of the manufactured teeth and observes an abnormality, he/she further processes the artificial teeth or prosthetic teeth to optimize the shape of the teeth. The conventional articulator is used when no abnormality is observed after the maxillary base and the mandibular base are forcibly moved relative to the hinge portion through which the maxillary base is simply connected to the mandibular base. In the case where the hinge portion is not completely fixed to the maxillary base and the mandibular base, it is impossible to manufacture sophisticated artificial teeth. In an actual case, the patient wearing the artificial teeth feels severe pain.

Despite numerous efforts to solve the problems of the prior art, no satisfactory dental model articulators have been developed to date. Only a solution to the problems is to develop more sophisticated articulators for the manufacture of artificial teeth and prosthetic teeth.

In other words, artificial teeth or prosthetic teeth have to be manufactured very delicately and precisely. If artificial teeth or prosthetic teeth deviate from originally intended positions or a maxillary base and a mandibular base of an articulator are not correctly fixed to a hinge portion therebetween, that is to say, the artificial teeth are not fixed in correct positions on the articulator, the use of the artificial teeth causes great discomfort to a patient, and in an extreme case, accompanies severe pain. It is very important to check whether artificial teeth or prosthetic teeth are adapted to the structure of patient's teeth and to confirm which artificial or prosthetic teeth are not correct and need to be processed. However, since the dentist simply tries to move the conventional articulator to observe whether there is an abnormality, he/she may fail to find left and right movements of the articulator. In this case, sophisticated artificial teeth cannot be manufactured. This is believed to be a cause of pain in the patient.

In view of this situation, the present invention is intended to develop an articulator including a maxillary base, a mandibular base, and a latch fixing the maxillary base to the mandibular base in a hinge portion, wherein a T-shaped arm of the maxillary base is inserted into loops of the mandibular base to prevent the maxillary base and the mandibular base from moving left and right relative to each other, and the latch is fitted onto both sides of a support of the mandibular base to prevent the maxillary base and the mandibular base from escaping from the hinge portion, thus enabling the manufacture of sophisticated artificial teeth.

As already known, in a conventional dental model articulator, cast stone is not properly separated from a maxillary base and a mandibular base after casting of a dental model. Further, the delicate cast stone is minutely moved left and right when it is separated from the maxillary base and the mandibular base, failing to manufacture sophisticated artificial teeth. The improper artificial teeth cause inconvenience and pain to a wearer. In view of this, the present invention is intended to develop a sophisticated articulator free from problems encountered in the processing of artificial teeth or prosthetic teeth.

### SUMMARY

It is therefore an object of the present invention to provide a dental model articulator which includes a latch by which a T-shaped arm of a maxillary base is fixedly inserted into loops of a mandibular base to prevent the maxillary base and the mandibular base from moving left and right, thus enabling precise model casting.

It is another object of the present invention to provide a latch that is formed with an elastic wing to be easily attached to and detached from a hinge portion, thus facilitating separation of a maxillary base from a mandibular base.

In order to achieve the above objects of the present invention, there is provided an articulator including a maxillary base, a mandibular base, and a latch latched to both sides of the mandibular base to fix the maxillary base to the mandibular base so that the maxillary base and the mandibular base can be prevented from moving left and right in a hinge portion connecting an arm of the maxillary base to loops of the mandibular base.

The hinge arm of the maxillary base is fixed to the loops of the mandibular base by fitting the latch onto the mandibular base. The T-shaped arm of the maxillary base is inserted into holes formed in the loops of the mandibular base. The T-shaped arm of the maxillary base has protrusions formed at both distal ends to limit the movement range of the maxillary base and the mandibular base. After the T-shaped arm of the maxillary base is fitted into the loops of the mandibular base, the latch is fitted onto the mandibular base along a support of the mandibular base. The latch has an elastic wing in the upper portion thereof The elastic wing is latched to a stopper of the mandibular base to clamp the hinge portion. With this configuration, the maxillary base can be detached from the mandibular base when a slight force is applied to the elastic wing.

The latch is fitted onto both sides of the mandibular base in the lengthwise direction of the support of the mandibular base. A circular recess is formed in the upper portion of the latch. The circular recess is engaged with the T-shaped arm of the maxillary base to allow for smooth movement of the arm of the maxillary base. The elastic wing is formed with a ledge, which is elastically latched to the stopper of the mandibular base. The stopper of the mandibular base is slightly inclined to prevent it from escaping from the ledge of the elastic wing.

In the dental model articulator of the present invention including the maxillary base, the mandibular base, and the latch adapted to fix the maxillary base to the mandibular base in which the T-shaped arm of the maxillary base is fixedly inserted into the loops of the mandibular base, one of the loops of the mandibular base is covered with a hinge rotating portion of the latch, and the support of the mandibular base is surrounded by a body of the latch. With this configuration, the support of the mandibular base is fixed by latching plates and latching ledges of the latch. The elastic wing is formed on the hinge rotating portion of the latch in the lengthwise direction of the latch body and is latched to the stopper of the mandibular base. The latching plates are formed in a direction perpendicular to the latch body to cover the support of the mandibular base. Each of the latching ledges is formed at a lateral side of the latching plate to firmly fix the support of the mandibular base.

The elastic wing formed on the hinge rotating portion of the latch is fixedly latched to the stopper of the mandibular base by the ledge protruding toward the hinge rotating portion. The recess of the hinge rotating portion of the latch is slightly semicircular in shape to ensure smooth movement of the T-shaped arm of the maxillary base.

As is apparent from the foregoing description, the latch is fitted onto the support of the mandibular base to fix the maxillary base to the mandibular base so that the maxillary base and the mandibular base cannot be moved left and right. Therefore, a precise observation of the movements of the maxillary base and the mandibular base enables the manufacture of sophisticated artificial teeth and prosthetic teeth.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a maxillary base and a mandibular base of a dental model articulator of the present invention;

FIG. 2 is a view illustrating a latch for fixing a maxillary base to a mandibular base; FIG. 3a is an exploded view of a dental model articulator of the present invention; and FIG. 3b is a view for explaining a state in which a maxillary base is fixed to a mandibular base by a latch.

### DETAILED DESCRIPTION

The present invention will now be described in detail with reference to the accompanying drawings.

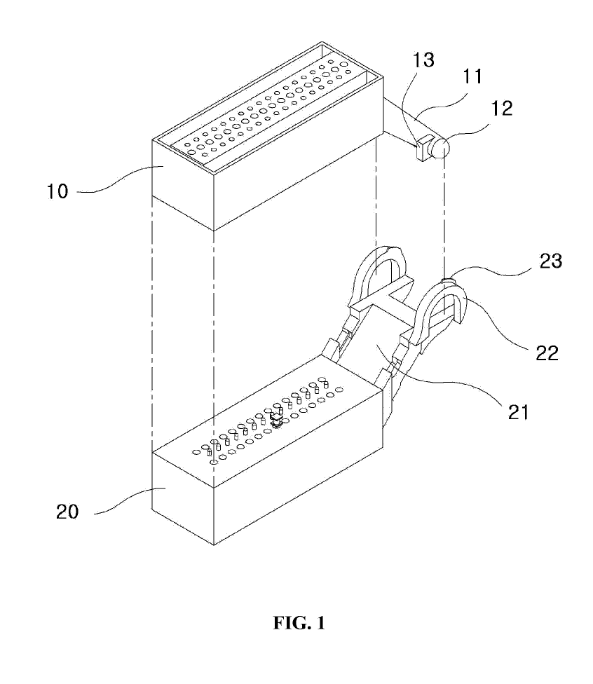

FIG. 1 is a view illustrating a maxillary base 10 and a mandibular base 20 of a dental model articulator of the present invention.

As illustrated in FIG. 1, the maxillary base 10 has the same structure and shape as the mandibular base 20, except for different hinge connection portions. The maxillary base has a T-shaped arm. The T-shaped arm is rounded at distal ends 12 thereof so as to facilitate the movement of the maxillary base. The maxillary base has protrusions 13 formed close to both ends of the T-shaped arm 11. The protrusions 13 are latched to the mandibular base when the maxillary base 10 and the mandibular base 20 are moved upward and downward. This construction limits the movement of the maxillary base 10 and the mandibular base 20 within a predetermined range.

The T-shaped arm 11 of the maxillary base is inserted into loops 22 formed at one end of a support 21 of the mandibular base to allow the maxillary base and moves upward and downward within the loops 22. However, although the maxillary base and the mandibular base are precisely designed, a clearance arises between the maxillary base and the mandibular base for the movement of the maxillary base and the mandibular base. This clearance also permits the left and right movement of the maxillary base 10 and the mandibular base 20, making it impossible to manufacture sophisticated artificial teeth.

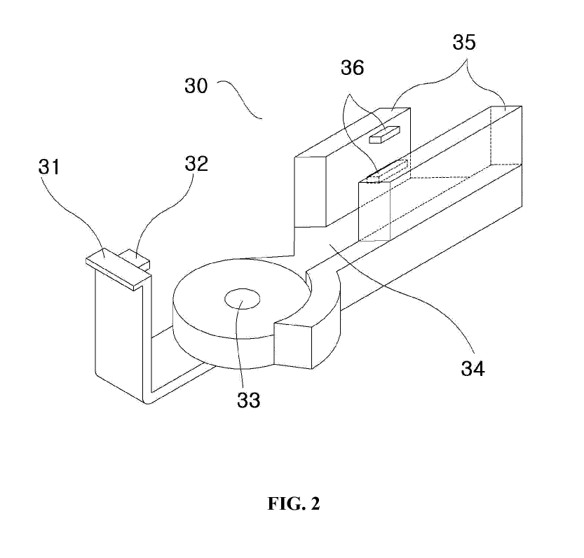

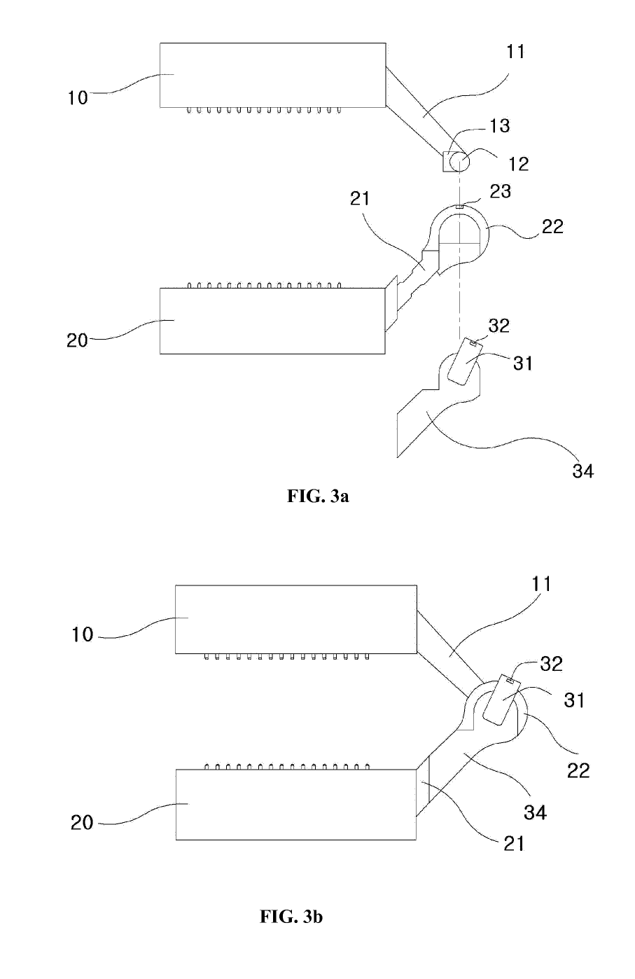

FIG. 2 is a view illustrating a latch for fixing the maxillary base 10 to the mandibular base in a hinge portion therebetween. The latch has a latch body 34 fitted onto the support of the mandibular base, latching plates 35 formed in a direction perpendicular to the latch body 34 to fix the support of the mandibular base, latching ledges 36 formed at lateral sides of the respective latching plates, a hinge rotating portion 33 connected to the latch body and having a circular recess in which the arm of the maxillary base inserted into the loops of the mandibular base can move, and an elastic wing 31 connected to the hinge rotating portion 33 and fixedly latched to a stopper of the mandibular base. As illustrated in FIG. 2, the latch is fixed to both sides of the support 21 of the mandibular base and surrounds the support 21. The latch body is fully fitted onto the support of the mandibular base. With this configuration, the circular recess of the hinge rotating portion 33 is engaged with the T-shaped arm of the maxillary base to allow for smooth rotation of the T-shaped arm of the maxillary base.

Specifically, the elastic wing connected to the hinge rotating portion is in the shape of an “L” and has a ledge 32 latched to the stopper 23 of the loop of the mandibular base. When a force is applied to the ledge 32 to separate the latch, the elasticity of the ledge 32 allows the ledge 32 to escape from the stopper 23 of the loop of the mandibular base. The latch body 34 is formed opposite to the elastic wing connected to the hinge rotating portion 33. The latching plates 35 are formed at both sides in the lengthwise direction of the latch body and are fixed to the support 21 of the mandibular base. Each of the latching ledges 36 is formed at a lateral side of the latching plate. The latching ledges are fitted into grooves of the support 21 of the mandibular base to fix the latch to the mandibular base.

FIG. 3a is an exploded view of the dental model articulator of the present invention. As illustrated in FIG. 3a, the maxillary base is moved in a state in which the T-shaped arm is fitted into the loops 22 of the mandibular base. The T-shaped arm 11 of the maxillary base is moved upward and downward in the circular hinge rotating portion formed on the latch body 34. The protrusions 13 formed close to both ends of the T-shaped arm 11 serve to permit the maxillary base and the mandibular base to move only within a limited range. The T-shaped arm 11 of the maxillary base is inserted into the loops 22 of the mandibular base such that the maxillary base and the mandibular base move only upward and downward without moving left and right. The latch adapted to fix the maxillary base to the mandibular base fixes the T-shaped arm connected to the center of the circular hinge rotating portion 33 and the loops 22 of the mandibular base. The elastic wing 31 of the latch is firmly fixed to the loops of the mandibular base and the ledge 32 protrudes inwardly from the elastic wing 31. The ledge 32 slightly protrudes toward the support of the mandibular base from the distal end of the elastic wing. The ledge 32 is elastically moved and escapes from the stopper 23 of the mandibular base when a slight force is applied thereto. As a result, the latch is detached from the maxillary base and the mandibular base.

Hinge connections of a maxillary base and a mandibular base of a conventional dental model articulator get loose and are moved relative to each other during use, making it impossible to manufacture sophisticated artificial teeth. In contrast, in the dental model articulator of the present invention, the latch can be used to fix the maxillary base to the mandibular base, enabling the manufacture of sophisticated artificial teeth.

FIG. 3b is a view for explaining a state in which the maxillary base 10 is fixed to the mandibular base 20 by the latch 30. The dental model articulator is actually used in the state illustrated in FIG. 3b. The latch is fixed to the support 21 of the mandibular base into which the T-shaped arm 11 of the maxillary base is fitted, as illustrated in FIG. 3b. One of the loops 22 of the mandibular base is fitted into the circular hinge rotating portion 33 formed at the distal end of the latch. This configuration allows for upward and downward movements of the maxillary base and the mandibular base while preventing left and right movements of the maxillary base and the mandibular base. Unlike the conventional dental model articulator in which the maxillary base and the mandibular base are moved through hinge connections therebetween, the movements of the maxillary base and the mandibular base are fixed by the latch, specifically, the elastic wing 31 elastically fixes the T-shaped arm 11 of the maxillary base fitted into the loops 22 of the maxillary base. This configuration prevents left and right movements of the maxillary base 10 and the mandibular base 20, enabling the manufacture of sophisticated artificial teeth. The articulator of the present invention is suitable for orthodontic use.

What is claimed is:

1. A dental model articulator comprising a maxillary base having a T-shaped arm, a mandibular base having loops, and a latch adapted to fix the maxillary base to the mandibular base, wherein the T-shaped arm of the maxillary base is fixedly inserted into the loops of the mandibular base, one of the loops of the mandibular base is covered with a hinge rotating portion of the latch, a support of the mandibular base is surrounded by a body of the latch and fixed by latching plates and latching ledges of the latch, and an elastic wing is formed on the hinge rotating portion of the latch in the lengthwise direction of the latch body and is latched to a stopper of the mandibular base.

2. The dental model articulator of claim 1, wherein the latching plates are formed in a direction perpendicular to the latch body to cover the support of the mandibular base, and each of the latching ledges is formed at a lateral side of the latching plate to firmly fix the support of the mandibular base.

3. The dental model articulator of claim 1, wherein the elastic wing formed on the hinge rotating portion of the latch is fixedly latched to the stopper of the mandibular base by a ledge protruding toward the hinge rotating portion.

4. The dental model articulator of claim 1, wherein the hinge rotating portion of the latch has a slightly semicircular recess at the center thereof to ensure smooth movement of the T-shaped arm of the maxillary base.
